(19) United States
(12) Patent Application Publication
(10) Pub. No.: US 2013/0245881 A1
(43) Pub. Date: Sep. 19, 2013

(54) System and Method for Monitoring the Environment In and Around an Automobile

(71) Applicant: Christopher G. Scarbrough, Gulfport, MS (US)

(72) Inventor: Christopher G. Scarbrough, Gulfport, MS (US)

(21) Appl. No.: 13/419,627

(22) Filed: Mar. 14, 2012

(51) Int. Cl. G06F 7/00

(52) U.S. Cl. 701/36

(57) ABSTRACT

A system and method for monitoring the environment in and around an automobile includes a memory, a processor in data communication with the memory and with a vehicle computer module, at least one outside camera in data communication with the processor that is configured to mount inside an automobile interior area and positioned to receive video data from outside the automobile, and a motion sensor configured to detect movement outside of the automobile. The system includes programming that causes the processor to determine if the automobile is at rest and, if so, to actuate the motion sensor. Programming causes the processor to actuate the outside camera when the processor has determined that the automobile is at rest and the motion sensor has detected movement outside the automobile. A global positioning system is configured to record geographic position data and time data if the automobile crashes.

### BACKGROUND OF THE INVENTION

This invention relates generally to monitoring systems and, more particularly, to a system and method for monitoring and recording the environment inside and outside of an automobile. Even more particularly, the present invention selectively records the audio and visual environment inside a vehicle, the visual environment outside the vehicle, and records the global position of the vehicle in case of a crash.

There are numerous occasions in which an automobile owner, driver, or passenger wishes that he had a video or audio record of an incident. The incident may be inside or outside of the vehicle. For instance, the occupants of a vehicle may desire to have exterior video of a traffic stop by law enforcement so as to potentially controvert law enforcement's post-incident statements or reports. In other words, a vehicle driver normally has no way to controvert a police officer's accusations. Further, a driver may desire that the interior area of the vehicle be video or audio recorded in order to verify the position or condition of passengers during an accident or while the driver has stepped inside a store for a few minutes. In addition, recording vehicle condition data may be desired, such as functionality of vehicle devices or the geographic position of the vehicle during an accident.

Various devices have been proposed in the art for video recording events outside a vehicle. For instance, it is well known that some law enforcement vehicles may have a dashboard mounted camera that records events in front of the vehicle, such as during a traffic stop. Although assumably effective for their intended purposes, the existing devices do not provide a monitoring system that activates one or more outwardly directed cameras when motion is detected alongside a stationary vehicle. Further, the existing devices do not provide a monitoring system that also provides audio and video recording inside the vehicle or that records global position data when a vehicle crash is detected.

Therefore, it would be desirable to have a system and method for monitoring and recording the environment inside and outside of an automobile.

### SUMMARY OF THE INVENTION

A system and method for monitoring the environment in and around an automobile according to the present invention includes a memory configured to store programming and data, a processor in data communication with the memory and with a vehicle computer module, at least one outside camera in data communication with the processor that is configured to mount inside an automobile interior area and positioned to receive video data from outside the automobile interior area when actuated, and a motion sensor configured to detect movement outside of the automobile when actuated. The system includes programming that causes the processor to communicate with the vehicle computer module to determine if the automobile is at rest and, if so, to actuate the motion sensor. There is programming that causes the processor to actuate the at least one outside camera when the processor has determined that the automobile is at rest and the motion sensor has detected movement outside the automobile.

The system further includes a global positioning system (“GPS”) mounted to the vehicle and in communication with the processor. The GPS is actuated when the automobile is determined to have crashed, such as by the processor detecting that airbags have been deployed or by reading other vehicle computer data. When actuated, the GPS outputs global position data that is then stored in memory along with an associated time data. Successive GPS data is obtained and stored after a crash is detected until the automobile is completely at rest. In this way, data is stored in memory that may be helpful for use in accident reconstruction in later insurance claims and litigation.

Therefore, a general object of this invention is to provide a system and method for monitoring areas inside and around an automobile.

Another object of this invention is to provide a monitoring system and method, as aforesaid, having at least one outwardly directed camera situated in an automobile and configured to record video data outside the automobile.

Still another object of this invention is to provide a monitoring system and method, as aforesaid, having a motion sensor situated to detect motion outside the automobile.

Yet another object of this invention is to provide a monitoring system and method, as aforesaid, having programming that causes the outwardly directed camera to be actuated when the automobile is at rest and the motion sensor has detected motion outside the automobile.

A further object of this invention is to provide a monitoring system and method, as aforesaid, having a global positioning system configured to output and store position data when the automobile detects a crash condition.

A still further object of this invention is to provide a monitoring system and method, as aforesaid, having an interiorly directed camera configured to record video data inside an interior of the automobile when actuated.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a top diagrammatic view of a system and method for monitoring inside and outside of an automobile according to a preferred embodiment of the present invention;

FIG. 2 is rear diagrammatic view of the system as in FIG. 1;

FIG. 3 is an isolated view on an enlarged scale of a camera of the system as in FIG. 1 removed from the rest of the system;

FIG. 4 is an isolated view on an enlarged scale of a microphone of the system as in FIG. 1 removed from the rest of the system;

FIG. 5 is a flowchart illustrating the logic of the processor according to the present system and method; and

FIG. 6 is a block diagram illustrating the electronic components of the present system.

### DESCRIPTION OF THE PREFERRED EMBODIMENT

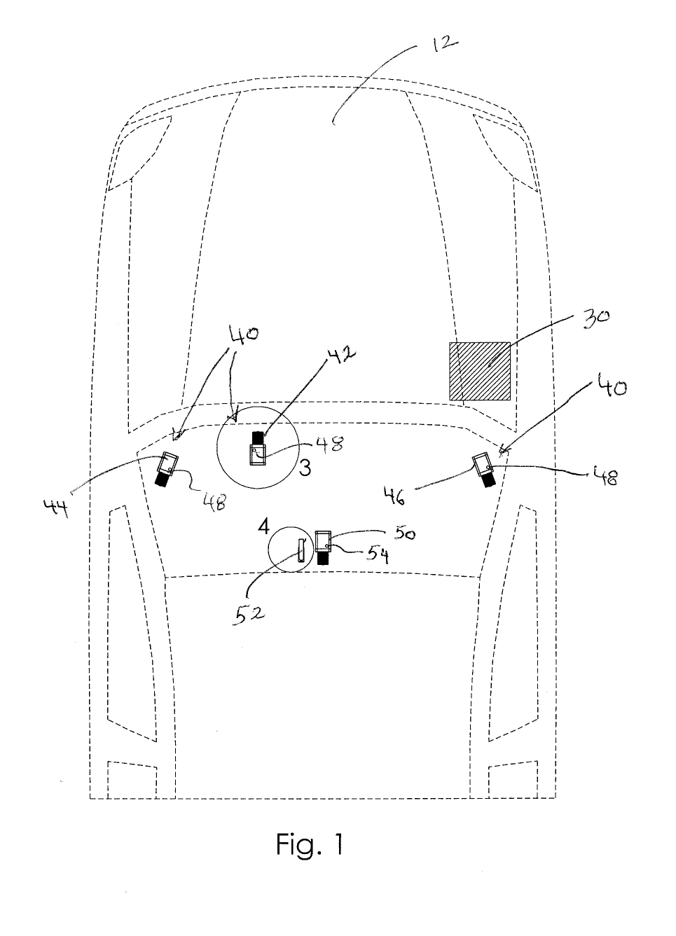

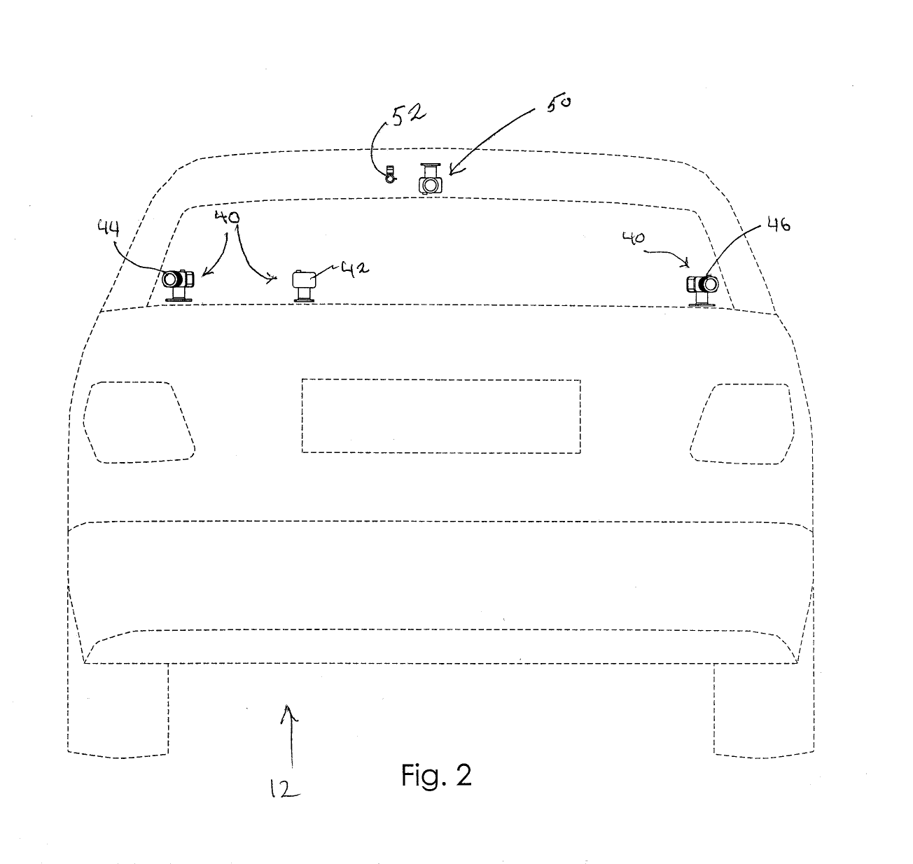

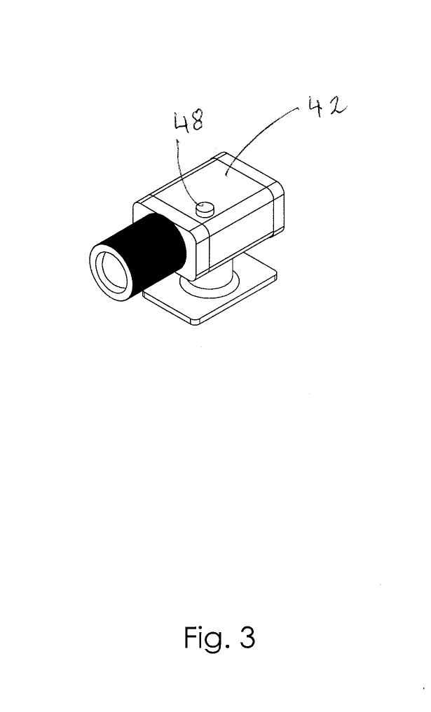

A system and method for monitoring and recording the environment inside and outside of an automobile will now be described in detail with reference to FIGS. 1 to 6 of the present invention. The monitoring system 10 includes a processor 20, a memory 22, a motion sensor 26, a global positioning system 30, at least one outside-directed camera 40, and an inside camera 50.

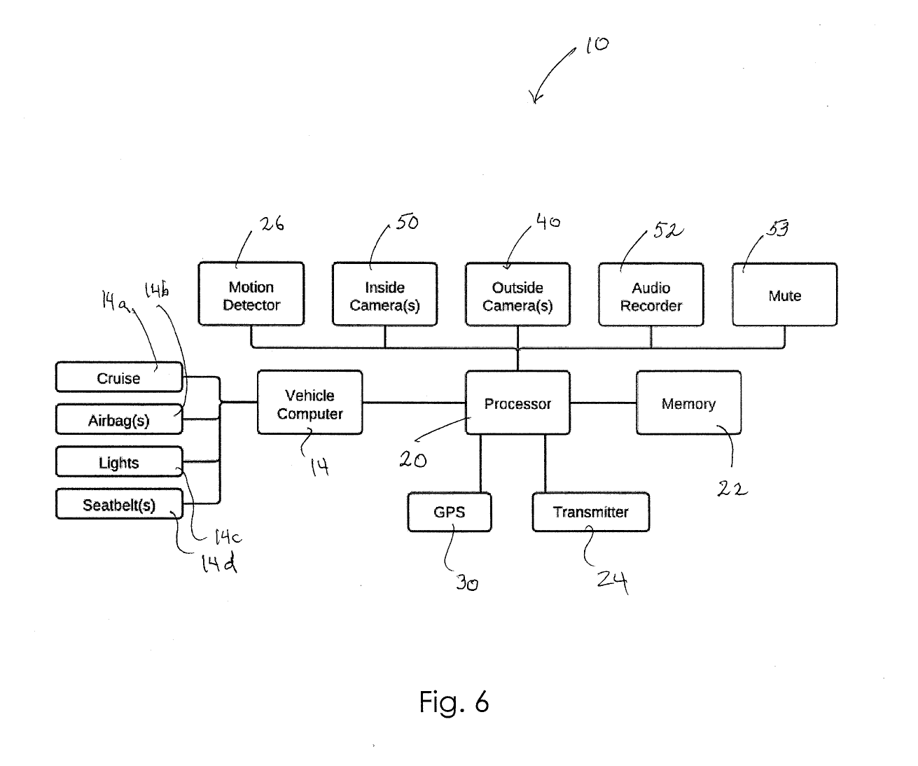

The processor 20 and memory 22 may be enclosed in an electronics case (not shown) and are in data communication with one another. The memory 22 includes programming for execution by the processor 20 and is configured to store data as will be described below. Preferably, the processor 20 is also in data communication with the vehicle computer module 14 of the automobile 12. A vehicle computer module 14 is known in the art to include and accumulate data from various vehicle systems such as activation of the airbags 14b, lights 14c, seat belts 14d, cruise control 14a, vehicle accelerator, brakes, transmission gear setting, and many other engine components (FIG. 6). Use of portions of this data will be important to the present system and method as will be discussed in further detail later.

The motion sensor 26 is in data communication with the processor 20. The motion sensor 26 may be situated inside or outside of the automobile, but is preferably situated to detect movement alongside (i.e. along the sides of) the automobile. For example, the motion sensor 26 is configured to detect motion proximate a driver side door, a passenger side door, or both. Accordingly, a reference herein to a motion sensor 26 may actually refer to multiple motion sensors situated at various locations about the exterior of the vehicle. Activation of the motion sensor 26 causes the motion sensor 26 to be energized to “look” for movement and to alert the processor 20 if and when it is detected.

Reference to an “outside camera” refers to a camera that is directed outwardly, i.e. a camera that may be mounted on the dashboard inside the interior area of the vehicle and situated to record video data outside of the vehicle. The monitoring system 10 includes at least one outside camera 40 although it is preferred that multiple outside cameras be employed. More particularly, a front camera 42 may be mounted on the automobile dashboard and be directed to record video data in front of the automobile. A driver side camera 44 may also be mounted to the dashboard but directed toward the driver side door's window so as to record the area adjacent the driver side door when actuated, e.g. a person approaching the driver door. A passenger side camera 46 may also be mounted to the dashboard but directed toward the passenger side door's window so as to record the area adjacent the passenger side door when actuated, e.g. a person approaching the passenger door. In addition, a rear camera (not shown) may be situated proximate a rear window of the automobile 12 and directed outwardly so as to record an area rearward of the automobile when actuated.

The system 10 includes programming that when executed by the processor 20 causes the processor 20 to actuate one or more outside cameras 40 to record video data when the automobile 12 is detected to be completely at rest and the motion sensor 26 has detected movement. It is understood that the processor 20 may be in communication with the motion sensor 26 first to detect if the automobile 12 is at rest and then again to sense movement adjacent the driver or passenger door. Alternatively, the processor 20 may be in communication with the vehicle computer module 14 to determine if the automobile is at rest, such as when an automobile speed is at zero, the transmission indicates the vehicle is in “park,” or any combinations of relevant data that is indicative of a vehicle at rest.

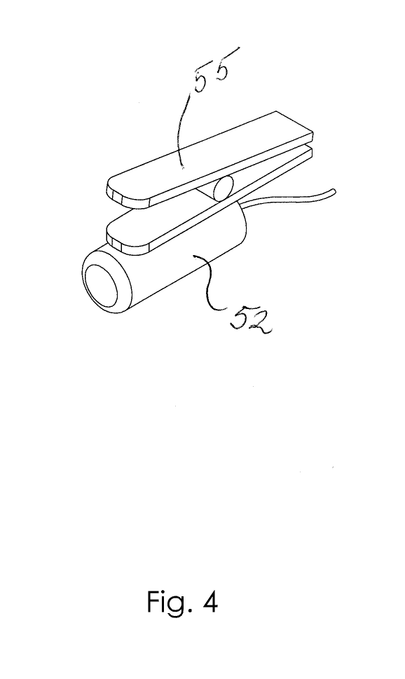

Further, the system 10 may include in inside camera 50 (also referred to an interior camera). The inside camera 50 may be mounted to the inner surface of the roof of the automobile 12 and be directed to record the interior area of the automobile 12 when actuated. A microphone 52 may also be situated in the interior area of the automobile either adjacent to or at another strategic location. In one embodiment, the audio device may include a mute button 53 so as to temporarily not record audible sounds. It is understood that the microphone 52 may be integrated with the inside camera 50 or be independent. The microphone 52 may include a mounting fastener 55 configured to selectively attach to a ceiling of the automobile interior compartment (FIG. 4). Both the inside camera 50 and the at least one outside camera 40 are electrically connected to the processor 20 and in data communication therewith. The processor 20, when executing programming stored in memory 22, may cause any of the cameras and microphone 52 to be activated as will be described in further detail below. The outside camera 40 and inside camera 50 may include a manual activation switch 48, 54, respectively, configured to enable a user to actuate the respective camera to begin recording. Alternatively, the inside camera 50 may be configured to begin recording video data when the automobile is started. Still another alternative is that there is programming that, when executed by the processor 20, causes the inside camera 50 to begin recording only when the automobile 12 is detected to be completely at rest.

The global positioning system 30 (“GPS”) may be included in the electronics housing (not shown) along with the processor 20 or at another location in the automobile 12, such as in the engine compartment (FIG. 1). The GPS 30 is configured to obtain global positioning data from the network of orbiting positioning satellites when actuated, as is generally known in the art. As will be described below, the system 10 includes programming causing the processor 20 to actuate the GPS 30 to obtain and store initial global position data to memory 22 when a crash is detected and then to continue obtaining interim global position data until the automobile is determined to be completely at rest. Specifically, new interim global position data may be output and stored every second or less than one second. Having multiple data points of global position data and the precise times of each reading will enable an accurate accident reconstruction showing the starting point, ending point, and interim positions of the vehicle. This information may prove to be valuable to plaintiffs, defendants, law enforcement, and insurance companies in later litigation. In fact, having this data may reduce the number of insurance claims that result in litigation for resolution. In addition, programming may be included that causes vehicle computer module data to be stored to memory immediately after a crash is detected, once the automobile is detected to be at rest, or both so as to contribute to obtaining the best record of what happened.

The system 10 may also include a transmitter 24 in data communication with the processor 20 that is configured to emit a cellular signal. More particularly, the system 10 and transmitter 24 include the capability of transmitting a signal to a user's cellular telephone or to another remote location such that the remote user may monitor data recorded by the cameras, GPS, or microphone.

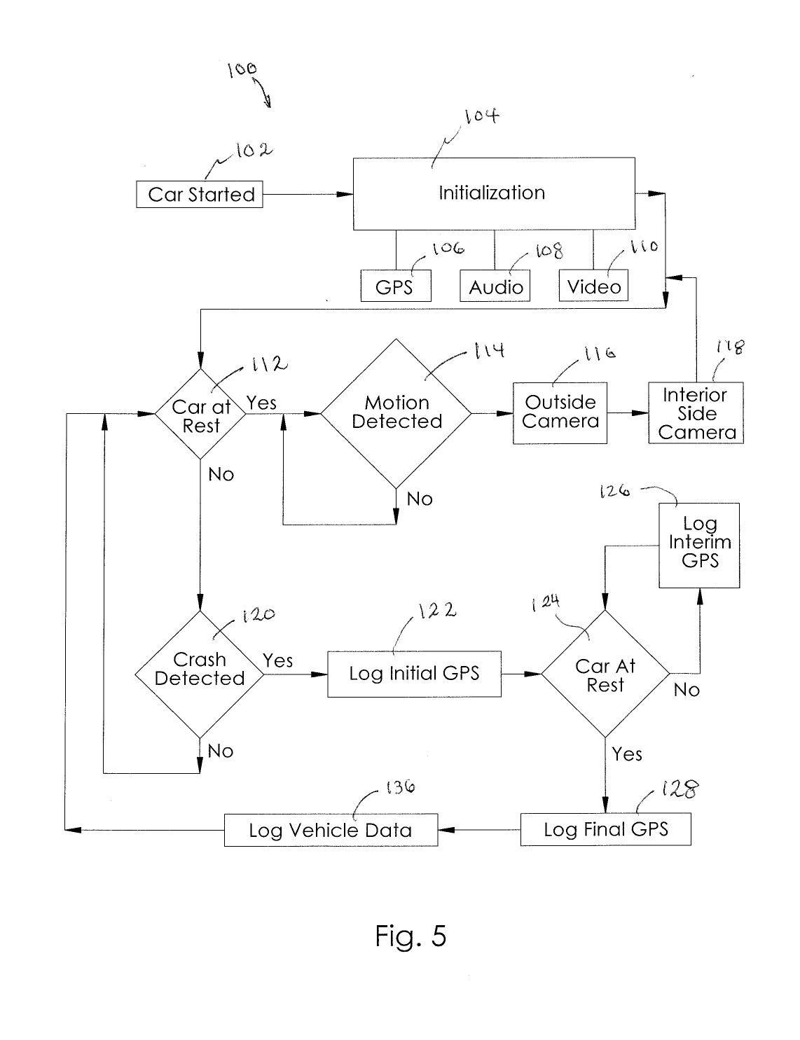

Preferably, the system 10 includes programming that, when executed by the processor 20, carries out the method of monitoring the environment in and around an automobile 12. An exemplary process/method 100 according to the present invention will now be described primarily with reference to FIG. 5.

Step 102 represents the starting of an automobile 12, after which the process 100 proceeds to step 104. At step 104, the components of the system 10 are initialized; for example, the process 100 may confirm operability of the GPS 106, operability of the audio device 108, operability of the video device(s) 110, and the like. As described above, the inside camera 50 may be automatically actuated at vehicle startup in some embodiments or may be manually actuated in other embodiments. After initiation of the system 10, the process 100 continues to step 10.

At step 112, the processor 20 determines if the automobile 12 is completely at rest, i.e. is not in motion. To determine if the automobile is at rest, the processor 20 may communicate with the vehicle computer module 14 and, specifically, access vehicle data such as speedometer, accelerator, transmission, or other appropriate data structures. If the vehicle is determined to be at rest, the process 100 proceeds to step 114; otherwise, the process 100 proceeds to step 120.

At step 114, the processor 20 first actuates the motion sensor 26 to detect motion as described above. If motion is detected, such as alongside one side or both sides of the automobile, the process 100 continues to step 116; otherwise, the process 100 returns to step 114 and continues to monitor the motion sensor 26. It is understood that if motion is detected, it may mean that someone is approaching the automobile, such as a police officer, and that the ensuing incident should be recorded.

At step 116, the outside video components are activated. This may include the front camera 42, driver side camera 44, passenger side camera 46, rear camera (not shown), or any combination thereof. The process 100 then proceeds to step 118. At step 118, the inside camera 50 may also be activated to record video data inside the interior area of the automobile. After activating the cameras, the process 100 returns control to step 112 where the process 100 again monitors if the car is at rest. It is understood that, once initiated, the video components may continue to record video data until the automobile returns to motion or manually terminated.

At step 120, the processor 20 determines if the automobile 12 has been involved in a crash. This may be accomplished by the processor 20 being in data communication with the vehicle computer module 14. Specifically, the processor 20 may query the computer module 14 if seatbelts have engaged, if airbags have deployed, or other appropriate parameters are indicative of a crash. Minor fender benders, of course, may not indicate a crash, but special data records would not be desirable in that situation anyway. If a crash is detected, then the process 100 continues to step 122; otherwise, the process 100 returns to step 112.

At step 122, the GPS 30 is activated to output initial global position data at the time of a crash and the output initial GPS data is stored in memory 22. The processor 20 also determines a current time and that time data is associated with the initial GPS data and stored in memory 22. In other words, the global position of the automobile 12 at the moment of the crash is preserved in memory 22 for later recall. After step 122, the process 100 continues to step 124.

At step 124, the processor 20 determines if the automobile 12 is completely at rest in a manner substantially similar to step 112. If it is determined that the automobile 12 is at rest, then the process 100 continues to step 128; otherwise, the process proceeds to step 126 at which the GPS 30 is again actuated to output interim global position data, which is stored to memory 22 along with associated time data. Then, the process 100 returns again to step 124 to determine if the automobile is yet at rest or rather still moving as a consequence of the crash.

If step 124 determines that the automobile 12 is completely at rest, then the process 100 continues to step 128. At step 128, the GPS 30 is actuated to output final global position data which is stored to memory 22 along with associated time data. This step represents the situation where the automobile has reached its final resting place in the crash incident and its geographic position is logged. After step 128, the process 100 continues to step 130 where a comprehensive output of data from the vehicle computer module 14 is stored to memory 22 for association with the final global position data. After step 130, the process 100 returns to step 112 where the process 100 once again monitors if the automobile 12 is at rest.

In use, the system and method described above enables the environment both inside and around the exterior of an automobile 12 to be monitored and recorded for later use. When the automobile 12 is in motion, the inside camera 50 may be selectively actuated by a user to record audio or video data inside the automobile, which provides a valuable record of events or conversations inside the car and also in case a record of occupants and their positions is needed following an automobile accident. When the vehicle comes to a stop, the motion sensor 26 is activated to detect motion along the sides of the vehicle. If such motion is detected, the outside (outwardly directed) camera(s) may be activated to record events outside the car, such as a law enforcement event or to record the environment at a rest stop, for example. In addition, the GPS 30 is activated if a crash is detected so as to store a record of the exact position and time of the accident. Records of the location and timing of a vehicle accident are helpful for accident reconstruction and to minimize litigation or insurance claims.

Accordingly, the system and method of the present invention increases the safety and security of vehicle occupants, reduces disputes over the facts of law enforcement traffic stops, and aids in the reconstruction of accidents.

It is understood that while certain forms of this invention have been illustrated and described, it is not limited thereto except insofar as such limitations are included in the following claims and allowable functional equivalents thereof.

1. A system for monitoring the environment of an automobile having a vehicle computer module, said monitoring system, comprising:
a memory configured to store programming and data;
a processor in data communication with said memory and with the vehicle computer module;
at least one outside camera in data communication with said processor that is configured to mount inside an automobile interior area and positioned to receive video data from outside of the automobile interior area when actuated;
a motion sensor configured to detect movement outside of the automobile when actuated;
programming in said memory that when executed by said processor causes said processor to communicate with the vehicle computer module to determine if the automobile is at rest and, if so, to actuate said motion sensor; and
programming in said memory that when executed by said processor causes said processor to actuate said at least one outside camera when said processor has determined that the automobile is at rest and said motion sensor has detected movement outside the automobile.

2. The monitoring system as in claim 1, further comprising:
a global positioning system (“GPS”) in data communication with said processor and configured to deliver global position data to said processor when actuated;
programming in said memory that when executed by said processor causes said processor to communicate with the vehicle computer module so as to determine if the automobile has crashed; and
programming in said memory that when executed by said processor causes said processor to actuate said GPS to output initial geographic position data when said processor determines the automobile has crashed.

3. The monitoring system as in claim 2, further comprising:
programming in said memory that when executed by said processor causes said processor to store said initial geographic position data in said memory; and
programming in said memory that when executed by said processor causes said processor to associate time data with said stored initial geographic position data.

4. The monitoring system as in claim 3, further comprising:
programming in said memory that when executed by said processor causes said processor to determine if the automobile is completely at rest a predetermined time after said initial global position data has been stored;
programming in said memory that when executed by said processor causes said processor to actuate said GPS to output interim global position data if the processor determines that the automobile is not completely at rest;
programming in said memory that when executed by said processor causes said processor to store said interim geographic position data in said memory; and
programming in said memory that when executed by said processor causes said processor to associate time data with said stored interim geographic data.

5. The monitoring system as in claim 4, further comprising:
programming in said memory that when executed by said processor causes said processor to determine if the automobile is completely at rest a predetermined time after said interim global position data has been stored;
programming in said memory that when executed by said processor causes said processor to actuate said GPS to output final global position data if the processor determines that the automobile is completely at rest;
programming in said memory that when executed by said processor causes said processor to store said final geographic position data in said memory; and
programming in said memory that when executed by said processor causes said processor to associate time data with said stored final geographic data.

6. The monitoring system as in claim 5, further comprising programming in said memory that when executed by said processor causes said processor to store vehicle data from the vehicle computer module in said memory immediately after said initial geographic data is stored in said memory.

7. The monitoring system as in claim 1, further comprising:
at least one inside camera in data communication with said processor that is configured to mount inside an automobile interior area and positioned to record video data from inside the automobile interior area when actuated; and
programming in said memory that when executed by said processor causes said processor to store said recorded video data from said inside camera to said memory.

8. The monitoring system as in claim 1, further comprising programming in said memory that when executed by said processor causes said processor to store said recorded video data from said outside camera in said memory;
wherein said at least one outside camera includes:
a front camera situated to record video data in front of the automobile when actuated;
a driver side camera situated to record video data of an exterior area proximate a driver side door of the automobile; and
a passenger side camera situated to record video data of an exterior area proximate a passenger side door of the automobile.

9. The monitoring system as in claim 7, wherein said inside camera is actuated when said automobile is started.

10. The monitoring system as in claim 7, wherein said inside camera includes a manual activation switch configured to selectively actuate said inside camera to record video data.

11. The monitoring system as in claim 1, further comprising programming in said memory that when executed by said processor causes said processor to actuate said inside camera to record video data when said processor has determined said automobile is at rest.

12. The monitoring system as in claim 1, further comprising programming in said memory that when executed by said processor causes said processor to actuate said inside camera when said processor has determined that the automobile is at rest and said motion sensor has detected movement outside the automobile.

13. The monitoring system as in claim 1, further comprising a microphone situated inside the automobile and configured to record audio data when said inside camera is actuated to record video data.

14. A method for recording the environment in and around an automobile having a vehicle computer module, comprises the steps:
providing:
a memory configured to store programming and data;
a processor in data communication with said memory and with the vehicle computer module;
at least one outside camera in data communication with said processor that is configured to mount inside an automobile interior area and positioned to receive video data from outside the automobile interior area when actuated;
a motion sensor configured to detect movement outside of the automobile when actuated;
determining if the automobile is at rest and, if so, to actuating said motion sensor;
actuating said at least one outside camera when said processor has determined that the automobile is at rest and said motion sensor has detected movement outside the automobile.

15. The monitoring method as in claim 14, further comprising the steps:
providing at least one inside camera in data communication with said processor that is configured to mount inside an automobile interior area and positioned to record video data from inside the automobile interior area when actuated;
storing said recorded video data from said inside camera to said memory.

16. The monitoring method as in claim 14, wherein said inside camera includes a manual activation switch configured to selectively actuate said inside camera to record video data.

17. The monitoring method as in claim 15, further comprising the step of actuating said inside camera to record video data when processor has determined said automobile is at rest.

18. The monitoring method as in claim 14, further comprising the steps:
providing a global positioning system (“GPS”) in data communication with said processor and configured to deliver global position data to said processor when actuated;
determining if the automobile has crashed; and
actuating said GPS to output initial geographic position data if the automobile is determined to have crashed;
storing said initial geographic position data in said memory; and
associating time data with said stored initial geographic data.

19. The monitoring method as in claim 18, further comprising the steps:
determining if the automobile is completely at rest a predetermined time after said initial global position data is stored;
actuating said GPS to output interim global position data if the automobile is determined not to be completely at rest;
storing said interim geographic position data in said memory; and
associating time data with said stored interim geographic data.

20. The monitoring method as in claim 19, further comprising the steps:
determining if the automobile is completely at rest a predetermined time after said interim global position data is stored;
actuating said GPS to output final global position data if the automobile is determined to be completely at rest;
storing said final geographic position data in said memory; and
associating time data with said stored final geographic data.

21. The monitoring method as in claim 14, further comprising:
a transmitter in data communication with said processor; and
programming in said memory that when executed by said processor causes said transmitter to transmit said recorded video data recorded by said outside camera as a cellular telephone signal.
